(19) United States
(12) Patent Application Publication
(10) Pub. No.: US 2013/0275556 A1
(43) Pub. Date: Oct. 17, 2013

(54) REMOTE PROVISIONING OF A DOWNLOADABLE IDENTITY MODULE INTO ONE OF SEVERAL TRUSTED ENVIRONMENTS

(71) Applicants: Johan Hjelm, Tokyo (JP); Shinta Sugimoto, Kanagawa (JP)

(72) Inventors: Johan Hjelm, Tokyo (JP); Shinta Sugimoto, Kanagawa (JP)

(73) Assignee: TELEFONAKTIEBOLAGET L M ERICSSON (PUBL), STOCKHOLM (SE)

(21) Appl. No.: 13/996,704

(22) PCT Filed: Dec. 23, 2010
(86) PCT No.: PCT/EP10/70691

§ 371 Date: Jun. 21, 2013

(51) Int. Cl. H04L 29/08

(52) U.S. Cl. CPC H04L 67/1074
USPC 709/217

(57) ABSTRACT

This invention relates to methods and apparatuses for implementing remote provisioning of a downloadable identity module into one of several Trusted Environments (7) available at a mobile device (1). A server (2) performs a selection of one of the Trusted Environments (7) available at the mobile device (1) for which at least one of one or more home operators (3) can provide downloadable identity modules, selects one of the one or more home operators (3) which can provide downloadable identity modules for the selected Trusted Environment, and manages the provisioning of a downloadable identity module to the mobile device (1).

### FIELD OF THE INVENTION

This invention relates to methods and apparatus for implementing remote provisioning of a downloadable identity module to mobile telecommunications devices. More particularly, the invention relates to a method and apparatus for selecting a trusted environment from a plurality of trusted environments available at a mobile device into which a downloadable identity module should be provided.

### BACKGROUND TO THE INVENTION

An entity that has subscribed for the provision of services to a mobile device such as a mobile telephone is required to have an associated identity module, often referred to as a Subscriber Identity Module (SIM), which identifies the subscriber and the services to which the subscriber is entitled. The term identity module includes a collection of security data and functions that allow a device to access a communication network. The type of identity module required depends on the particular mobile device and the network over which it is to be used, for example a mobile device operating over the IP Multimedia Subsystem (IMS) requires an IP Multimedia Services Identity Module (ISIM), whereas a mobile device operating over the Universal Mobile Telecommunications System (UMTS) requires a Universal Subscriber Identity Module (USIM)

When a mobile device is purchased it is necessary to provide the device with an identity module before the device can be used. The process is referred to as “provisioning” the device. Typically, the provisioning process is carried out manually, for example by sales personnel when the mobile device is purchased, or with a partial degree of automation, e.g. via a Point of Sale (PoS). The current 3^{rd} Generation Partnership Project (3GPP) system defines the use of a USIM/ISIM application stored in a Universal Integrated Circuit Card (UICC) as a means of securely storing, among other data, the data required to access a network. In a world of billions of devices, the currently established manual or semi-automated procedures for handling credentials in UICC are non-efficient, non-scalable and non-user friendly. Furthermore, the shortcomings of these procedures are particularly apparent when considering provisioning for machine-to-machine (M2M) and connected consumer electronics (CCE) devices.

3GPP TR 22.838 and TR 33.812 propose the use of a remote provisioning and change of subscription procedure for M2M Equipment (M2ME) that does not require human intervention at the location of the M2ME. These remote provisioning procedures make use of a downloadable Machine Communication Identity Module (MCIM). The term MCIM refers to the M2M specific identity module. A typical downloadable MCIM includes credentials, executables (including algorithms and a system of files and access control mechanisms) and data (e.g. file contents, security policy, etc), and is stored in a Trusted Environment (TRE) provided in the M2ME. The TRE provides some hardware and software protection for the provisioning, storage, execution and management of the MCIM applications. The TRE might be a completely separate module (e.g. UICC or TPM) or it might share memory and CPU etc, with the device. Since it might be possible to move the TRE between devices (as in the UICC case) a subscription is bound to the TRE identity rather than the device identity. Furthermore, since the device is not fully trusted, decryption of the credentials must be performed inside the TRE, and not in the hosting device.

FIG. 1 illustrates schematically the network architecture used for implementing these remote provisioning procedures. This network architecture includes a number of entities providing services to the M2ME, and with which the M2ME can communicate. These entities include the Visited Network Operator (VNO), the Registration Operator (RO), the Selected Home Operator (SHO) and the Platform Validation Authority (PVA).

In order to perform network authentication and MCIM provisioning, the M2ME must obtain provisional IP connectivity. To do so, the M2ME makes use of the basic network access (i.e. air interface) provided by the VNO. The IP connectivity is then provided by the Initial Connectivity Function (ICF) of the RO. The RO also provides a Discovery and Registration Function (DRF), which helps the M2ME discover and register itself with the SHO, which is the M2ME's intended home network operator. In order for the M2ME to be able to connect to the RO and obtain information about the SHO, it needs to be pre-provisioned with a PCID (Provisional Connectivity ID), which is a temporary private identity that identifies each M2ME. The PCID, where required, should be installed in the M2ME by the supplier in order to allow the M2ME to register in a 3GPP network without yet being associated with any specific SHO. The PCID follows the same format as the IMSI.

After the M2ME discovers and registers itself with the SHO, it then needs to download the MCIM application to the TRE. However, before the SHO allows this download procedure, it first must request that the PVA authenticate and validate the integrity of the TRE. Once this integrity check is successfully completed, the SHO authorises a Download and Provisioning Function (DPF) of the RO to provision the MCIM application into the M2ME's TRE. The MCIM may be generated by the SHO and provided to the DPF, or alternatively, the MCIM may simply authorise the DPF to provide the M2ME with an MCIM on its behalf. 3GPP TR 33.812 also describes several variations of these procedures, which serve to enhance security, operability, and other factors. These include methods which leverage the presence of a UICC, as well as those which assume that a UICC is not present.

### SUMMARY

Whilst the remote provisioning procedures have been defined in relation to M2ME, they could equally be implemented in order to provide a downloadable identity module to any type of mobile device, mobile terminal or user equipment. Furthermore, 3GPP TR 33.812 states that an M2ME should support at least one TRE, leaving open the possibility that an M2ME could have more than one TRE. However, only one TRE can be selected to provide the identity and associated credentials for performing authentication and key agreement (AKA) to connect to a network. As such, it has been recognised here that, if a mobile device were provided with more then one TRE, there would be a need to ensure that the appropriate TRE is used when attempting provisioning of a downloadable identity module.

It is therefore an aim of the present invention to provide a method and apparatus for selecting a trusted environment from a plurality of trusted environments available at a mobile device into which a downloadable identity module application should be provided.

According to a first aspect of the present invention there is provided a method of operating a server to implement provisioning of a downloadable identity module into one of several Trusted Environments available at a mobile device. The method comprises the following steps:
for each of one or more home operators capable of providing downloadable identity modules, maintaining information regarding Trusted Environments for which the home operator can provide downloadable identity modules;
obtaining information regarding the Trusted Environments available at the mobile device;
selecting one of the Trusted Environments available at the mobile device for which at least one of the one or more home operators can provide downloadable identity modules;
selecting one of the one or more home operators which can provide downloadable identity modules for the selected Trusted Environment; and
managing the provisioning of a downloadable identity module to the mobile device.

The server may be a Registration Operator server. The downloadable identity module is obtained from the selected home operator and provisioned into the selected Trusted Environment.

The step of maintaining information regarding the Trusted Environments for which the home operator can provide downloadable identity modules may comprise receiving information regarding the Trusted Environments for which the home operator can provide downloadable identity modules during establishment of a relationship between the server and the home operator.

The step of obtaining information regarding the Trusted Environments available at the mobile device may comprise receiving a request from the mobile device for selection of one of the Trusted Environments, the request including information regarding the Trusted Environments available at the mobile device.

The information regarding the Trusted Environments available at the mobile device may comprise capabilities and/or features of each of the Trusted Environments. Alternatively, or in addition, the information regarding the Trusted Environments available at the mobile device may comprise an identifier for each of the Trusted Environments.

The step of obtaining information regarding the Trusted Environments available at the mobile device may further comprise, for each of the Trusted Environments available at the mobile device, using the identifier of the Trusted Environment to identify a further server that can provide capabilities and/or features of the Trusted Environment, and obtaining the capabilities and/or features from the further server. The further server may be a Platform Validation Authority server.

The information regarding Trusted Environments for which a home operator can provide downloadable identity modules may comprise an identifier for each of the Trusted Environments for which the home operator can provide downloadable identity modules. Alternatively, or in addition, the information regarding Trusted Environments for which a home operator can provide downloadable identity modules may comprise capabilities and/or features which are required by the home operator in order to provide downloadable identity modules.

The step of selecting one of the Trusted Environments for which at least one of the one or more home operators can provide downloadable identity modules may comprise:
comparing the capabilities and/or features with the capabilities and/or features required by each of the one or more home operators; and
selecting one of the Trusted Environments that provides the capabilities and/or features required by at least one of the one or more home operators.

The step of managing the provision of a downloadable identity module into the selected Trusted Environment may comprise receiving the downloadable identity module from the selected home operator, and sending the downloadable identity module to the mobile device. This step may further comprise notifying the mobile device of the selected Trusted Environment, receiving a request from the mobile device for provision of a downloadable identity module into the selected Trusted Environment, and relaying the request to the selected home operator.

According to a second aspect of the present invention there is provided a method of operating a mobile device having several Trusted Environments into which a downloadable identity module can be provisioned. The method comprises the steps of:
sending a request to a server for selection of one of the Trusted Environments into which a downloadable identity module should be provisioned, the request including information regarding the Trusted Environments available at the mobile device;
receiving a response from the server identifying a selected one of the Trusted Environments;
receiving a downloadable identity module from the server; and
provisioning the downloadable identity module into the identified Trusted Environment.

The information regarding the Trusted Environments available at the mobile device may comprise capabilities and/or features. Alternatively, or in addition, the information regarding the Trusted Environments available at the mobile device may comprise an identifier for each of the Trusted Environments.

The method may further comprise the step of, after receiving the response from the server, sending a request to the server for provisioning of a downloadable identity module into the identified Trusted Environment. The method may further comprise, after receiving the response from the server, preparing the identified Trusted Environment to receive a downloadable identity module, and notifying the server that the identified Trusted Environment has been prepared. The server may be a Registration Operator server.

According to a third aspect of the present invention there is provided a method of operating a server that is capable of providing downloadable identity modules. The method comprises:
establishing a relationship between the server and a further server;
during the establishment of the relationship, sending to the further server, information regarding Trusted Environments for which the server can provide downloadable identity modules;
receiving a request, from the further server, for provision of a downloadable identity module into a Trusted Environment available at a mobile device; and
sending the downloadable identity module to the further server.

The information regarding Trusted Environments may comprise capabilities and/or features of Trusted Environments, which are required by the server in order for the server to provide downloadable identity modules.

The server may be a home operator server. The further server may be a Registration Operator server.

An identity module may be any of a Machine Communication Identity Module, a Subscriber Identity Module, a Universal Subscriber Identity Module, a Virtual Subscriber Identity Module and an IP Multimedia Services Identity Module.

According to a fourth aspect of the present invention there is provided a server configured to implement the provisioning of a downloadable identity module into one of several Trusted Environments available at a mobile device. The server comprises:
a transceiver for obtaining, from one or more home operators capable of providing downloadable identity modules, information regarding Trusted Environments for which each of the one or more home operators can provide downloadable identity modules, and for obtaining information regarding the Trusted Environments available at the mobile device;
a Trusted Environment selection function for selecting one of the Trusted Environments for which at least one of the one or more home operators can provide downloadable identity modules;
a home operator selection function for selecting one of the one or more home operators which can provide downloadable identity modules for the selected Trusted Environment; and
a downloading and provisioning function for managing the provisioning of a downloadable identity module to the mobile device.

The server may be a Registration Operator server. The downloading and provisioning function may be arranged to obtain the downloadable identity module from the selected home operator and provision the downloadable identity module into the selected Trusted Environment.

The transceiver may be further arranged to receive a request from the mobile device for selection of one of the Trusted Environments, the request including information regarding the Trusted Environments available at the mobile device. The transceiver may be further arranged to receive information regarding the Trusted Environments, the information comprising capabilities and/or features. The transceiver may be further arranged to receive information regarding the Trusted Environments, the information comprising an identifier for each of the Trusted Environments.

The server may further comprise a resolution database for using each of the Trusted Environment identifiers to identify a further server that can provide capabilities and/or features of the Trusted Environment. The Trusted Environment selection function may then be further arranged to obtain, from each of the identified further servers using the transceiver, the capabilities and/or features of each of the Trusted Environments from each identified further server.

The Trusted Environment selection function may be further arranged to obtain information, from each of the one or more home operators using the transceiver, the information comprising an identifier for each of the Trusted Environments for which the home operator can provide downloadable identity modules. The Trusted Environment selection function may be further arranged to obtain information, from each of the one or more home operators using the transceiver, the information comprising capabilities and/or features which are required by the home operator in order to provide a downloadable identity module.

The Trusted Environment selection function may be further arranged to compare the capabilities and/or features with the capabilities and/or features required by each of the one or more home operators, and select one of the Trusted Environments that provides the capabilities and/or features required by at least one of the one or more home operators.

The downloading and provisioning function may be further arranged to notify the mobile device of the selected Trusted Environment, receive the downloadable identity module from the selected home operator, and transmit the downloadable identity module to the mobile device. The downloading and provisioning function may be further arranged to receive a request from the mobile device for provisioning of the downloadable identity module into the selected Trusted Environment, and relay the request to the selected home operator.

The server may further comprise a discovery and registration function for establishing a relationship between the server and each of the one or more home operators, and, during the establishment of a relationship, for using the transceiver to obtain the information regarding the Trusted Environments for which the home operator can provide downloadable identity modules.

The server may further comprise a home operator database for storing the information regarding the Trusted Environments for which each of the one or more home operators can provide downloadable identity modules.

According to a fifth aspect of the present invention there is provided a mobile device having several Trusted Environments into which a downloadable identity module can be provisioned. The mobile device comprises:
a transceiver for sending a request to a server for selection of one of the Trusted Environments, the request including information regarding each of the Trusted Environments, for receiving a response from the server identifying a selected one of the Trusted Environments, and for receiving a downloadable identity module from the server; and
a switching function for provisioning of the downloadable identity module into the identified Trusted Environment.

The mobile device may further comprise a detection function for detecting the Trusted Environments available at the mobile device and for generating information regarding each of the available Trusted Environments. The detection function may be further arranged to generate information comprising capabilities and/or features of each of the plurality of Trusted Environments. Alternatively, or in addition, the detection function may be further arranged to generate information comprising an identifier for each of the plurality of Trusted Environments.

The transceiver may be further arranged to send a request to the server for provisioning of the downloadable identity module into the identified Trusted Environment.

According to a sixth aspect of the present invention there is provided a server configured to provide downloadable identity modules. The server comprises:
a connection function for establishing a relationship between the server and a further server;
a database for storing information regarding the Trusted Environments for which the server can provide downloadable identity modules; and
a transceiver for sending the information to the further server, for receiving a request, from the further server, for provision of a downloadable identity module into a Trusted Environment available at a mobile device, and for sending the downloadable identity module to the further server.

The server may be a home operator node. The database may be configured to store information regarding Trusted Environments, the information comprising an identifier for each of the Trusted Environments. Alternatively, or in addition, the database is configured to store information regarding the Trusted Environments, the information comprising capabilities and/or features that are required by the server in order to provide a downloadable identity module.

According to a seventh aspect of the present invention there is provided a computer program comprising computer program code means adapted to perform all the steps of the first aspect when said program is run on a computer.

According to an eighth aspect of the present invention there is provided a computer program according to the seventh aspect embodied on a computer readable medium.

According to a ninth aspect of the present invention there is provided a computer program comprising computer program code means adapted to perform all the steps of the second aspect when said program is run on a computer.

According to a tenth aspect of the present invention there is provided a computer program according to the ninth aspect embodied on a computer readable medium.

According to an eleventh aspect of the present invention there is provided a computer program comprising computer program code means adapted to perform all the steps of the third aspect when said program is run on a computer.

According to a twelfth aspect of the present invention there is provided a computer program according to the eleventh aspect embodied on a computer readable medium.

The above aspects enable selection of a Trusted Environment from a plurality of Trusted Environments available at a mobile device into which a downloadable identity module application should be provisioned. The above aspects also provide that, if there are several home operators available that can provide a downloadable identity module into at least one of Trusted Environments available at a mobile device, then one of these home operators can be selected. This in turn provides that a Registration Operator can act as broker to select the most favourable home operator. In doing so, the above aspects allow for increased flexibility in the hardware configuration of mobile devices.

### BRIEF DESCRIPTION OF THE DRAWINGS

Some embodiments of the present invention will now be described in detail with reference to the accompanying drawings, in which:

FIG. 1 illustrates schematically a network architecture used for implementing remote provisioning;

FIG. 2 is an example signalling flow diagram of the remote provisioning of a downloadable identity module to a mobile device having a plurality of Trusted Environments;

FIG. 3A is an example flow diagram illustrating the steps performed by a mobile device having a plurality of Trusted Environments to implement remote provisioning of a downloadable identity module;

FIG. 3B is an example flow diagram illustrating the steps performed by a Registration Operator to implement remote provisioning of a downloadable identity module to a mobile device having a plurality of Trusted Environments;

FIG. 3C is an example flow diagram illustrating the steps performed by a Home Operator in order to support remote provisioning of a downloadable identity module to a mobile device having a plurality of Trusted Environments; and

FIG. 4 illustrates schematically an embodiment of a remote provisioning system for implementing remote provisioning of a downloadable identity module to a mobile device having a plurality of Trusted Environments.

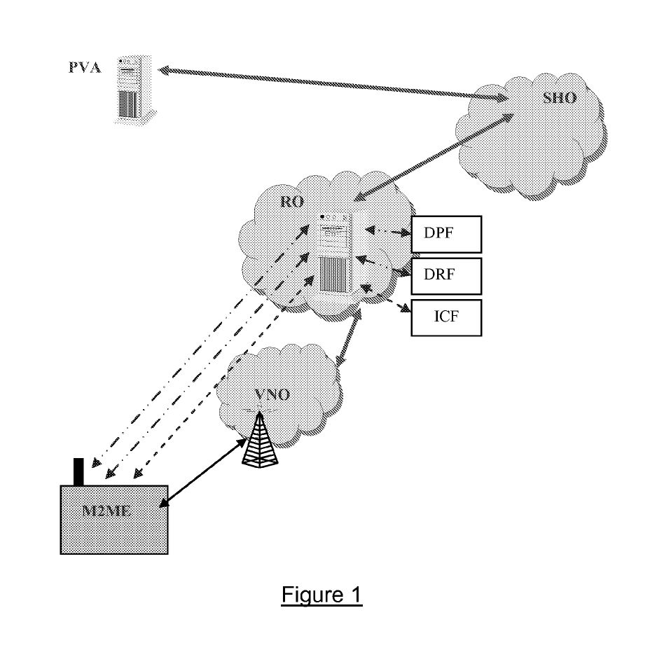

### DETAILED DESCRIPTION

By way of example, consider a mobile device which has a built-in TRE and a UICC tray into which a UICC customized for identity module remote provisioning is inserted. The UICC holds a Javacard applet which is capable of provisioning an identity module into the secure environment inside the UICC with the assistance of backend enablers inside the network. In this regard, the UICC/Javacard can be considered to be a TRE that can be provisioned with one or more downloadable identity module applications. The mobile device therefore has two TREs on which identity modules from different operators can be provisioned. However, a SHO may require that a downloadable identity module is only provisioned into the built-in TRE. For example, this could be because the device, and therefore the built-in TRE, is provided by that SHO. Alternatively, this could be because both the SHO and the TRE trust the same Certificate Authority (CA) as a root of trust, whilst the TRE provided by UICC does not. As such, a downloadable identity module provided by the SHO requires the TRE into which the SHO is provisioned to have certain features and/or capabilities. The built-in TRE should therefore be used to provision the mobile device with a downloadable identity module for authentication with the SHO, and any attempt to remotely provision the identity module provided by the SHO into TRE provided by the UICC would fail. However, the standards do not currently define any mechanism for selecting or switching between several TREs.

There will now be described a method of implementing selection of a TRE from a plurality of TREs available in a mobile device. According to this method, a mobile device with more than one TRE would request selection of one of the TREs into which a downloadable identity module should be provisioned and which of the available home operators can provide the downloadable identity module for the selected TRE, with the downloadable identity module then being provisioned into the selected TRE at the mobile device, from the selected home operator.

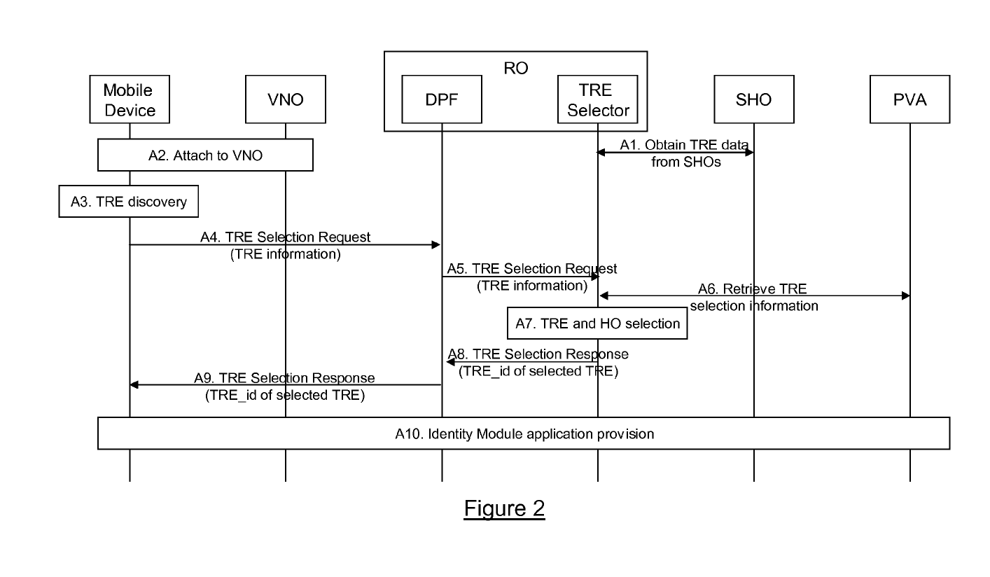

FIG. 2 is an example signalling flow diagram of the remote provisioning of a downloadable identity module to a mobile device having a plurality of TREs, including the selection of one of the plurality of TREs. The steps performed are as follows:
A1. A RO maintains information regarding the Trusted Environments for which the available home operators are capable of providing downloadable identity modules. For example, a TRE selection function could identify all of the available home operators and establish a relationship with each home operator. The DRF could then obtain the information regarding the Trusted Environments for which each home operator is capable of providing downloadable identity modules during the process of establishing this relationship. Of course, this information may be obtaining by other functional entities provided at the RO, such as the DRF.
A2. The mobile device attaches to the VNO according to the standard procedures described in 3GPP TR 33.812. For example, this could include the mobile device sending an attach message to the VNO including a PCID, the VNO contacting the RO, and the RO sending a Bootstrap message to the mobile device including the IP connectivity parameters and the address of the DPF.
A3. The mobile device then performs a TRE discovery procedure to detect the TREs available at the mobile device. As a result, the mobile device generates a set of information regarding all of the TREs available at the mobile device, including an identifier (TRE_id) for each TRE.
A4. The mobile device then sends a TRE selection request message, including the TRE information, to the DPF provided by the RO.
A5. The DPF forwards the TRE selection request message to the TRE selection function also provided by the RO.
A6. Depending upon the TRE information providing by the mobile device, or the information provided by the home operators, then the RO may be required to contact one or more PVAs in order to obtain information on the capabilities and/or features of one or TREs. However, this step is optional.
A7. Using the TRE information, and the information obtained from the home operators, the TRE selection function selects one of the TREs that is to be used for the remote provisioning of a downloadable identity module. As part of this selection process, the RO may also select a home operator that is to provide the downloadable identity module application, if more than one home operator is available. For example, each home operator may be capable of providing a downloadable identity module for certain types of TRE, but not others, such that only a particular combination of TRE and home operator will be able to successfully implement remote provisioning.
A8. The TRE selection function sends a TRE selection response message to the DPF that includes the TRE_id of the selected TRE.
A9. The DPF forwards the TRE selection response message to the mobile device.
A10. The mobile device then proceeds with the standard remote provisioning procedure as described in 3GPP TR 33.812. For example, the mobile device contacts the DPF at the RO and includes relevant information of the mobile device and the selected TRE (e.g. the platform validation information). The RO then connects to the SHO and relays the relevant information. The SHO then requests that the PVA validate the authenticity and integrity of the TRE before delivering the encrypted identity module application to the RO for downloading to the mobile device.

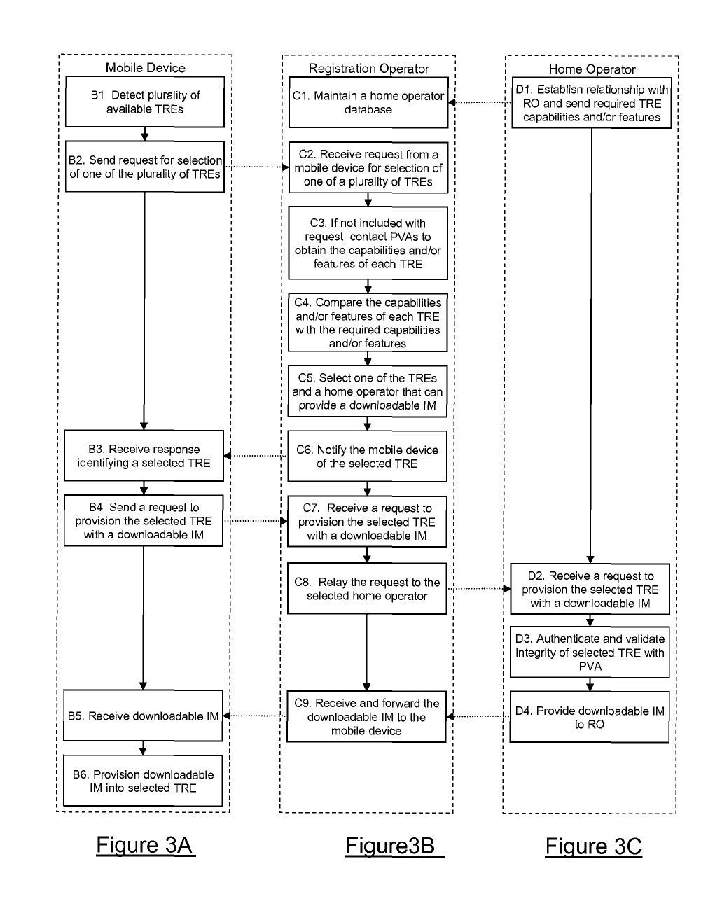

FIG. 3A is an example flow diagram illustrating the steps (B1 to B6) performed by the mobile device. FIG. 3B is an example flow diagram illustrating the steps (C1 to C9) performed by the Registration Operator, and FIG. 3C is an example flow diagram illustrating the steps (D1 to D4) performed by the Home Operator.

In order to perform the selection of one of the TREs, the TRE selection function needs to know which home operators are available to the RO, and also needs to know information regarding the TREs for which each of the available home operators can provide a downloadable identity module. The RO should therefore maintain a home operator database that stores information regarding the TREs for which each of the available home operators can provide a downloadable identity module. In order to maintain the information stored in the home operator database, the home operators could be configured to provide information regarding the TREs for which they can provide a downloadable identity module each time they establish or re-establish a relationship with the RO.

The information regarding the TREs for which each of the available home operators can provide a downloadable identity module could include an identifier for each TRE or each type of TRE that they support. Alternatively, this information could include details of the capabilities and/or features that the home operator requires a TRE to have in order to be able to provide a downloadable identity module for that TRE. For example, these capabilities and/or features may include details of the manufacturer of the TRE, the hardware that provides the TRE, the incoming and outgoing logical and physical interfaces of the TRE, the encryption mechanisms used by the TRE, security mechanisms used by the TRE, etc.

Similarly, the information regarding the TREs available at the mobile device can also include details of the capabilities and/or features of each of the TREs. This capability and/or feature information can then be compared with the required capability and/or feature information stored in the home operator database to determine which of the TREs available at the mobile device can be provided with a downloadable identity module by at least one of the home operators.

Alternatively, if the information regarding the TREs available at the mobile device only includes an identifier for the TRE, then the RO should maintain a resolution database that stores TRE identities, each TRE identity being associated with an identity of a server that can provide capability and/or feature information for that TRE. The TRE selection function could then use this database to resolve the identities of each of the TREs available at the mobile device to the identity of a server that can provide capability and/or feature information for the TRE. For example, the resolution database could identify a PVA that is responsible for authenticating and validating each identified TRE. The TRE selection function could then contact each of the identified servers to obtain the capability and/or feature information of each TRE in order to compare this information with the required capability and/or feature information stored in the home operator database.

If the TRE selection function determines that there is more than one home operator available that can provide a downloadable identity module to the mobile device, then the TRE selection function will be required to perform selection of one of these home operators. To do so, the TRE selection function may make use of a set of rules that determine which of the TRE's available at the mobile device should be selected and which of the home operators that can provide a downloadable identity module should be selected to provide the downloadable identity module. If the TRE selection function performs selection of a home operator when selecting a TRE, then the TRE selection function should store details of this selection in order to ensure that any request to provision a downloadable identity module into the selected TRE are fulfilled using the selected home operator.

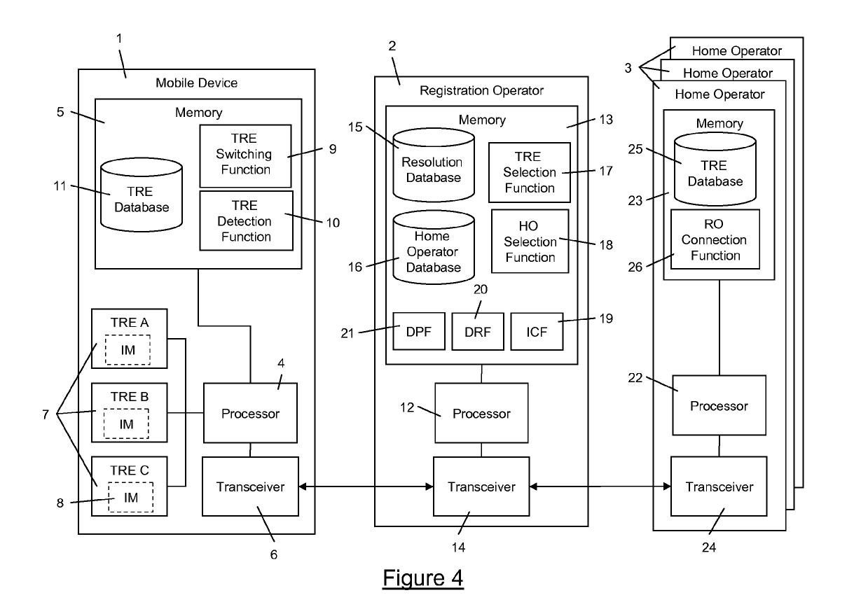

FIG. 4 illustrates schematically an embodiment of a remote provisioning system for implementing the selection of a TRE, and for implementing the use of the selected TRE. The remote provisioning system comprises a mobile device 1, a Registration Operator 2, and a number of Home Operators 3, each of which can be implemented as a combination of computer hardware and software.

The mobile device 1 comprises a processor 4, a memory 5, a transceiver 6 and a plurality of TREs 7, TRE A, TRE B and TRE C, each capable of storing at least one identity module 8. The memory 5 stores the various programs/executable files that are implemented by the processor 4, and also provides a storage unit for any required data. The programs/executable files stored in the memory, and implemented by the processor, include a TRE Switching Function 9 and a TRE Detection Function 10. The TRE Switching Function 9 switches between all of the TREs available to the mobile device as required, enabling the mobile device to make use of any active downloaded identity module regardless of which TRE it has been installed into. The TRE Detection Function 10 identifies all of the TREs available at the mobile device, including detecting if and when a TRE has been added to or removed from the mobile device 1. The TRE Detection Function 10 also determines relevant information for each TRE, and maintains a TRE Database 11 stored in the memory 5. For example, this relevant information can include an identifier for each TRE 7 available at the mobile device 1, and capability and/or feature information for each TRE 7. The TRE Database 1 can then be used to provide the TRE information for sending to the Registration Operator 2. Further, the TRE Detection Function 10 can report to the RO 2 whenever there is a change in the TRE Database 11.

The Registration Operator 2 comprises a processor 12, a memory 13, and a transceiver 14. The memory 13 stores the various programs/executable files that are implemented by the processor 12, and also provides a storage unit for any required data, including a Resolution Database 15 and a Home Operator Database 16. The programs/executable files stored in the memory 13, and implemented by the processor 12, include a TRE Selection Function 17 and a Home Operator Selection Function 18.

The Resolution Database 15 stores TRE identities, each TRE identity being associated with an identity of a server that can provide capability and/or feature information for that TRE, so that the TRE Selection Function 17 can use this database to resolve the identities of each of the TREs available at the mobile device to the identity of a server that can provide capability and/or feature information for the TRE. The Home Operator Database 16 stores information regarding the TREs for which each of the available Home Operators 3 can provide a downloadable identity module. The TRE Selection Function 17 uses the TRE information provided by the mobile device 1 together with the information in the Home Operator Database 16 to select one of the TREs available at the mobile device that is to be used for the remote provisioning of a downloadable identity module. Home Operator Selection Function 18 selects a Home Operator 3 that is to provide a downloadable identity module, if there is more than one home operator available that can provide a downloadable identity module to the mobile device. The Registration Operator 2 will further comprise an Initial Connectivity Function (ICF) 19, a Discovery and Registration Function (DRF) 20 and a Download and Provisioning Function (DPF) 21, as defined in 3GPP TR 33.812.

The Home Operators 3 comprise a processor 22, a memory 23, and a transceiver 24. The memory 23 stores the various programs/executable files that are implemented by the processor 22, and also provides a storage unit for any required data, including a TRE Database 25. The programs/executable files stored in the memory 23, and implemented by the processor 22, include a RO Connection Function 26. The TRE Database 25 stores information regarding the Trusted Environments for which the server can provide a downloadable identity module. For example, this information could include an identifier for each TRE or each type of TRE that is supported by the Home Operator 3. Alternatively, this information could include details of the capabilities and/or features that the Home Operator 3 requires a TRE to have in order to be able to provide a downloadable identity module for that TRE. The RO Connection Function 26 enables the Home Operator 3 to establish a relationship between the Home Operator 3 and Registration Operator 2.

The methods described above assume that each TRE can be addressed individually by means of a TRE identity that is used by the PVA Discovery Function and the Resolution Database in the RO, and the TRE Switching Function in the mobile device. For example, the TRE identity could include an identity of the manufacturer of the TRE and an additional identity that uniquely identifies the TRE to the manufacturer. Such an identifier would enable an appropriate PVA to be identified from the identity of the manufacturer.

The methods and apparatuses described above enable selection of a TRE from a plurality of TREs available at a mobile device into which a downloadable identity module application should be provisioned. They also provide that the SHO can be selected, provided that the SHO supports an available TRE, which in turn provides that the RO can act as broker to select the most favourable SHO. In addition, the methods and apparatuses described above also provide support for mobile devices that have a plurality of available TREs, including removable TREs (for example, UICC) thereby allowing for increased flexibility in the hardware configuration of mobile devices.

In addition, the methods and apparatuses described above provide that access and service authorization can be separated/decoupled in roaming scenarios. For example, this would allow a user who purchases a mobile device in a T-Mobile® store in Aachen (Germany) and who then takes the mobile device home to Wolfhaag (the Netherlands), to make use of a network provided by Proximus®, a network operator in Gemmenich (Belgium), if that network provides the strongest signal. In this case, the user would be able to use a T-Mobile® SIM for service authorization and a Proximus® SIM for connectivity.

Although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. For example, whilst the methods and apparatuses described above have referenced only two or three TREs, and only two or three SHOs and PVAs, the skilled person will recognise that these methods and apparatuses could equally be applied to any number of downloadable identity modules, TREs, SHOs or PVAs. Furthermore, given that a TRE can hold multiple downloadable identity modules, the methods and apparatuses outlined above could be used for a number of downloadable identity modules and TREs simultaneously. Each feature disclosed or illustrated in the present specification may be incorporated in the invention, whether alone or in any appropriate combination with any other feature disclosed or illustrated herein.

1. A method of operating a server to implement provisioning of a downloadable identity module into one of several Trusted Environments available at a mobile device, the method comprising:
for each home operator included in a set of one or more home operators, maintaining information regarding Trusted Environments for which the home operator can provide downloadable identity modules;
obtaining information regarding the Trusted Environments available at the mobile device;
selecting one of the Trusted Environments available at the mobile device for which at least one of the one or more home operators can provide downloadable identity modules;
selecting one of the one or more home operators which can provide downloadable identity modules for the selected Trusted Environment; and
managing the provisioning of a downloadable identity module to the mobile device.

2. The method as claimed in claim 1, wherein the step of obtaining information regarding the Trusted Environments available at the mobile device comprises:
receiving a request from the mobile device for selection of one of the Trusted Environments, the request including information regarding the Trusted Environments available at the mobile device.

3. The method as claimed in claim 1, wherein the information regarding the Trusted Environments available at the mobile device comprises capabilities and/or features.

4. The method as claimed in claim 1, wherein the information regarding the Trusted Environments available at the mobile device comprises an identifier for each of the Trusted Environments.

5. The method as claimed in claim 4, wherein the step of obtaining information regarding the Trusted Environments available at the mobile device further comprises:
for each of the Trusted Environments available at the mobile device, using the identifier of the Trusted Environment to identify a further server that can provide capabilities and/or features of the Trusted Environment, and obtaining the capabilities and/or features from the further server.

6. A method as claimed in claim 5, wherein the further server is a Platform Validation Authority server.

7. The method as claimed in claim 3, wherein the information regarding Trusted Environments for which a home operator can provide downloadable identity modules comprises:
capabilities and/or features which are required by the home operator in order to provide downloadable identity modules.

8. The method as claimed in claim 7, wherein the step of selecting one of the Trusted Environments for which at least one of the one or more home operators provide downloadable identity modules comprises:
comparing the capabilities and/or features with the capabilities and/or features required by each of the one or more home operators; and
selecting one of the Trusted Environments that provides the capabilities and/or features required by at least one of the one or more home operators.

9. The method as claimed in claim 1, wherein the server is a Registration Operator server.

10. A method of operating a mobile device having several Trusted Environments into which a downloadable identity module can be provisioned, the method comprising:
sending a request to a server for selection of one of the Trusted Environments into which a downloadable identity module should be provisioned, the request including information regarding the Trusted Environments available at the mobile device;
receiving from the server a response identifying a selected one of the Trusted Environments;
receiving a downloadable identity module from the server; and
provisioning the downloadable identity module into the identified Trusted Environment.

11. The method as claimed in claim 10, wherein the information regarding the Trusted Environments available at the mobile device comprises capabilities and/or features.

12. The method as claimed in claim 11, wherein the information regarding the Trusted Environments available at the mobile device comprises an identifier for each of the Trusted Environments.

13. The method as claimed in claim 10, and further comprising the step of:
after receiving the response from the server, sending a request to the server for provisioning of a downloadable identity module into the identified Trusted Environment.

14. The method as claimed in claim 10, wherein the server is a Registration Operator server.

15. A method performed by a first server that is capable of providing downloadable identity modules, the method comprising:
sending to a further server information regarding Trusted Environments for which the first server can provide downloadable identity modules;
receiving a request, from the further server, for provisioning of a downloadable identity module into a Trusted Environment available at a mobile device; and
transmitting the downloadable identity module to the further server.

16. The method as claimed in claim 15, wherein the information comprises:
capabilities and/or features of Trusted Environments, which are required by the first server in order for the sever to provide downloadable identity modules.

17. The method as claimed in claim 15, wherein the first server is a home operator server.

18. The method as claimed in claim 15, wherein the further server is a Registration Operator server.

19. The method as claimed in claim 15, wherein the identity module is any of a Machine Communication Identity Module, a Subscriber Identity Module, a Universal Subscriber Identity Module, a Virtual Subscriber Identity Module and an IP Multimedia Services Identity Module.

20. A server configured to implement the provisioning of a downloadable identity module into one of several Trusted Environments available at a mobile device, the server comprising:
a transceiver for obtaining, from one or more home operators capable of providing downloadable identity modules, information regarding Trusted Environments for which each of the one or more home operators can provide downloadable identity modules, and for obtaining information regarding the Trusted Environments available at the mobile device;
a Trusted Environment selection function for selecting one of the Trusted Environments for which at least one of the one or more home operators can provide downloadable identity modules;
a home operator selection function for selecting one of the one or more home operators which can provide downloadable identity modules for the selected Trusted Environment; and
a downloading and provisioning function for managing the provisioning of a downloadable identity module to the mobile device.

21. The server as claimed in claim 20, wherein the transceiver is further arranged to receive a request from the mobile device for selection of one of the Trusted Environments, the request including information regarding the Trusted Environments available at the mobile device.

22. The server as claimed in claim 20, wherein the transceiver is further arranged to receive information regarding the Trusted Environments, the information comprising capabilities and/or features.

23. The server as claimed in claim 20, wherein the transceiver is further arranged to receive information regarding the Trusted Environments, the information comprising an identifier for each of the Trusted Environments.

24. The server as claimed in claim 23, and further comprising:
a resolution database for using each of the Trusted Environment identifiers to identify a further server that can provide capabilities and/or features of the Trusted Environment.

25. The server as claimed in claim 24, wherein the Trusted Environment selection function is further arranged to obtain, from each of the identified further servers, the capabilities and/or features of the Trusted Environment.

26. The server as claimed in claim 23, wherein Trusted Environment selection function is further arranged to obtain information, from each of the one or more home operators, the information comprising an identifier for each of the Trusted Environments for which the home operator can provide downloadable identity modules.

27. The server as claimed in claim 22, wherein the Trusted Environment selection function is further arranged to obtain information, from each of the one or more home operators, the information comprising capabilities and/or features which are required by the home operator in order to provide a downloadable identity module.

28. The server as claimed in claim 27, wherein the Trusted Environment selection function is further arranged to:
compare the capabilities and/or features with the capabilities and/or features required by each of the one or more home operators; and
select one of the Trusted Environments that provides the capabilities and/or features required by at least one of the one or more home operators.

29. The server as claimed in claim 20, wherein the server is a Registration Operator server.

30. A mobile device having several Trusted Environments into which a downloadable identity module can be provisioned, the mobile device comprising:
a transceiver for sending a request to a server for selection of one of the Trusted Environments, the request including information regarding each of the Trusted Environments, for receiving a response from the server identifying a selected one of the Trusted Environments, and for receiving a downloadable identity module from the server; and
a switching function for provisioning of the downloadable identity module into the identified Trusted Environment.

31. The mobile device as claimed in claim 30, and further comprising:
a detection function for detecting the Trusted Environments available at the mobile device and for generating information regarding each of the available Trusted Environments.

32. The mobile device as claimed in claim 31, wherein the detection function is further arranged to generate information comprising capabilities and/or features of each of the plurality of Trusted Environments.

33. The mobile device as claimed in claim 32, wherein the detection function is further arranged to generate information comprising an identifier for each of the plurality of Trusted Environments.

34. A server configured to provide downloadable identity modules, the server comprising:
a connection function for establishing a relationship between the server and a further server;
a database for storing information regarding Trusted Environments for which the server can provide downloadable identity modules; and
a transceiver for sending the information to the further server, for receiving from the further server a request for provisioning of a downloadable identity module into a Trusted Environment available at a mobile device, and for transmitting the downloadable identity module to the further server.

35. The server as claimed in claim 34, wherein the database is configured to store information regarding the Trusted Environments, the information comprising an identifier for each of the Trusted Environments.

36. The server (*as claimed in claim 34, wherein the database is configured to store information regarding the Trusted Environments, the information comprising capabilities and/or features that are required by the server in order to provide the downloadable identity module.

37. The server was claimed in claim 34, wherein the server is a home operator node.

38. A computer program product comprising a non-transitory computer readable medium storing computer program code, the computer program code comprising:
code for each home operator included in a set of one or more home operators, maintaining information regarding Trusted Environments for which the home operator can provide downloadable identity modules;
code for obtaining information regarding the Trusted Environments available at a mobile device;
code for selecting one of the Trusted Environments available at the mobile device for which at least one of the one or more home operators can provide downloadable identity modules;
code for selecting one of the one or more home operators which can provide downloadable identity modules for the selected Trusted Environment; and
code for managing the provisioning of a downloadable identity module to the mobile device.

39. (canceled)

40. A computer program product comprising a non-transitory computer readable medium storing computer program code, the computer program code comprising:
code for sending a request to a server for selection of a Trusted Environment into which a downloadable identity module should be provisioned, the request including information regarding a set of two or more Trusted Environments available at a mobile device;
code for processing a response transmitted by the server, the response identifying a selected one of the Trusted Environments;
code for obtaining a downloadable identity module from the server; and
code for provisioning the downloadable identity module into the identified Trusted Environment.

41. (canceled)

42. A computer program product comprising a non-transitory computer readable medium storing computer program code, the computer program code comprising:
code for sending to a server information regarding Trusted Environments for which a first server can provide downloadable identity modules;
code for processing a request, from the further server, for provisioning of a downloadable identity module into a Trusted Environment available at a mobile device; and
code for transmitting the downloadable identity module to the further server.

43. (canceled)
